(19) United States
(12) Patent Application Publication
(10) Pub. No.: US 2021/0235699 A1
(43) Pub. Date: Aug. 5, 2021

(54) Adjuvant Compositions Comprising a Tetramethylguanidine and a 4-Isothiazolin-3-One

(71) Applicant: Lonza, LLC, Morristown, NJ (US)

(72) Inventors: Rochelle Bradford, Decatur, GA (US); Kathryn Neely, Alpharetta, GA (US); Kevin Janak, Blauvelt, NY (US)

(21) Appl. No.: 17/054,540

(22) PCT Filed: Jul. 1, 2019
(86) PCT No.: PCT/IB2019/055603

§ 371 Date: Nov. 11, 2020

Related U.S. Application Data
(60) Provisional application No. 62/691,694, filed on Jun. 29, 2018.

(30) Foreign Application Priority Data
Jun. 29, 2018 (EP) 18180988.0

(51) Int. Cl. A01N 43/80; A01N 25/22; A01N 47/44

(52) U.S. Cl. CPC A01N 43/80; A01N 47/44; A01N 25/22

(57) ABSTRACT

The present invention relates to biocidal compositions comprising an isothiazolone biocidal active compound in combination with a guanidine adjuvant. These compositions are highly effective in preventing deterioration and decay caused by microbial contamination in very low concentrations so that the environmental or toxicological burden is low.

### FIELD OF THE INVENTION

The present invention relates to biocidal compositions comprising an isothiazolone biocidal active compound in combination with a guanidine adjuvant. These compositions are highly effective in preventing deterioration and decay caused by microbial contamination in very low concentrations so that the environmental or toxicological burden is low.

### BACKGROUND OF THE INVENTION

Biocidal agents are used in many fields to control the growth of harmful microorganisms and to prevent deterioration and decay caused by microbial contamination, microbial slime deposits and biofilms.

As used herein the term “biocide” is intended to include, but is not restricted to, bactericides and fungicides and/or algaecides, and “biocidal activity” refers to both, the elimination and the inhibition of growth of bacteria and fungi and/or algae.

Isothiazolones (4-isothiazolin-3-ones, terms used interchangeably herein) are highly effective biocides and widely used as broad-spectrum biocides in various industries. Two of the most widely used isothiazolone biocides are 5-chloro-2-methyl-4-isothiazolin-3-one (chloromethylisothiazolinone or CMIT) and 2-methyl-4-isothiazolin-3-one (methylisothiazolinone or MIT), which are also often used together in a 3:1 mixture (CMIT:MIT). However, MIT is allergenic and cytotoxic, and this has led to some concern over its use. Due to the increased use of these isothiazolinone-based preservatives in recent years, an increase in reported incidences of contact allergy to mixtures of MIT and CMIT has been reported. The 4-isothiazolin-3-one derivative 1,2-benzisothiazolin-3-one (BIT) exhibits a broad antimicrobial activity spectrum against bacteria, fungi and yeast and also exhibits a high degree of chemical and thermal stability. However, amounts of up to 500 ppm are required for a reliable and quick biocidal activity. N-(n-butyl)-1,2-benzisothiazolin-3-one (BBIT) is another biocide widely used in polymers, metal cutting oils, paints, and coatings for its antibacterial and antifungal properties, and usually requires an amount of 1.500 to 2.000 ppm to effect an adequate resistance against common bacteria or fungi, such as Aspergillus niger.

To broaden the effectiveness of biocidal compositions, isothiazolones have also been combined with various other biocides. For example, biocidal compositions comprising a pyrithione and a 2-alkylisothiazolin-3-one have been widely used in the past. Zinc pyrithione (ZPT) is a broad-spectrum antibacterial and antifungal agent. Due to its low solubility in water (8 ppm at neutral pH), zinc pyrithione is suitable for use in outdoor paints and other products that provide protection against mildew and algae.

Due to the large-scale use of isothiazolone biocides and pyrithione salts, there is an increasing concern over protection of the environment, in particular the aquatic environment. For example, isothiazolinones are contained in many daily consumer products (such as shampoo and shower gel), and have long been used for biological control of algae and sludge attached to sea cages or shipping vessels. In addition, the potential for skin sensitization linked to the isothiazolone biocides necessitates appropriate labelling and labelling requirements. Overall, the regulatory restrictions on the use of isothiazolone biocidal actives are thus increasing, and the use of this class of compounds will have to be further reduced in the future. Pyrithione salts are also discharged into the aquatic environment with industrial and civilian waste water. The recent and potential regulations on pyrithione salts typically used for similar applications will also result in a decrease in available pyrithione-based biocidal compositions.

Thus, it has become imperative to identify biocidal compositions that provide similar or improved performance, but that are less harmful to the health and environment.

The object of the invention is to provide a biocidal composition that exhibits a high degree of biocidal activity while keeping 4-isothiazolin-3-one levels very low. The inventors have surprisingly found that a guanidine adjuvant can boost the biocidal activity of 4-isothiazolin-3-one derivatives so that these compositions provide excellent biocidal activity with only very low amounts of said isothiazolones. The guanidine adjuvants according to the invention are cost-effective, and are not subject to the same strict regulatory limitations resulting from environmental or toxicological concerns. The resulting biocidal compositions are widely applicable for inhibiting the growth of bacteria, fungi and algae in technical materials such as paints, coatings, emulsion polymers or aqueous mineral slurries, and are particularly suited as in-can preservatives. The biocidal compositions achieve an efficacy similar to CMIT/MIT while satisfying long term preservation requirements of conventional in-can biocides. The presence of additional antimicrobial agents such as pyrithione salts, for example zinc or sodium pyrithione (ZnPT, NaPT) is not required. Also, the use of MIT can be avoided. The use of these biocidal compositions thus bears the advantage that humans and the environment are exposed to less pollution, and the cost of controlling harmful microorganisms is reduced.

### DETAILED DESCRIPTION OF THE INVENTION

The present invention is directed to a composition having biocidal properties that exhibits appropriate biocidal activity against microorganisms such as bacteria and fungi, and may be used to protect technical materials against deterioration and decay caused by contamination with these microorganisms.

The biocidal composition according to the invention comprises i) at least one 4-isothiazolin-3-one biocidal active compound and ii) at least one guanidine adjuvant of formula (I) or a salt thereof,

(CH₃)₂N—(C═NHR)—N(CH₃)₂ (I)

wherein R is H, C₁-C₃₀-alkyl, C₁-C₃₀-alkenyl, C₁-C₃₀-alkynyl, C₇-C₃₀-alkylaryl, C₅-C₁₂-aryl, or —COR′, wherein R′ is C₁-C₃₀-alkyl or

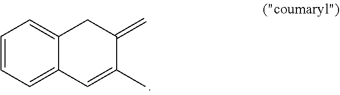

The at least one 4-isothiazolin-3-one biocidal active compound of the invention may be any 4-isothiazolin-3-one derivative known in the art that exhibits biocidal activity. For example, the at least one 4-isothiazolin-3-one biocidal active compound is selected from the group consisting of 1,2-benzisothiazolin-3-one (BIT), N-(n-butyl)-1,2-benzisothiazolin-3-one (BBIT), 5-chloro-2-methyl-2H-isothiazolin-3-one (CMIT), 2-methyl-2H-isothiazolin-3-one (MIT), 2-methyl-4,5-trimethylene-4-isothiazolin-3-one (MTI), 2-octyl-3(2H)-isothiazolone (OIT), dichloro-n-octyl-2H-isothiazolin-3-one (DCOIT), N-methyl-1,2-benzisothiazolin-3-one (nMBIT) and 2,2-dithiobis(N-methylbenzamide) (DTMB).

In a preferred embodiment, the at least one 4-isothiazolin-3-one biocidal active compound is 1,2-benzisothiazolin-3-one (BIT), or N-(n-butyl)-1,2-benzisothiazolin-3-one (BBIT), or a mixture thereof.

In another preferred embodiment, BIT is the sole biocidal active compound comprised in the composition. In another preferred embodiment, a mixture of BIT and BBIT is used as the biocidal active compound comprised in the composition.

In addition to the at least one 4-isothiazolin-3-one biocidal active compound, the biocidal compositions of the invention comprise at least one guanidine adjuvant of formula (I).

The term “adjuvant” as used herein refers to an additive that affects the performance of an active compound when used in combination, but does not exhibit biocidal activity itself in the compositions of the invention. While not being bound to theory, it is believed that the guanidine adjuvant of the invention increases the biocidal efficacy of the biocidal active compounds by aiding in solubilizing these active compounds, or by acting as carrier for said active compounds. As a result, only minimum amounts of isothiazolone are required in the biocidal composition of the invention for achieving the desired biocidal activity, so that these biocidal compositions provide a robust protection and preservation of the product or locus to be protected from harmful bacteria and fungi.

The at least one guanidine adjuvant comprised in the biocidal compositions of the invention is a guanidine derivative of formula (I) or a salt thereof,

(CH₃)₂N—(C═NHR)—N(CH₃)₂ (I)

wherein R is H, C₁-C₃₀-alkyl, C₁-C₃₀-alkenyl, C₁-C₃₀-alkynyl, C₇-C₃₀-alkylaryl, C₆-C₁₂-aryl, or —COR′, wherein R′ is C₁-C₃₀-alkyl or coumaryl.

R is selected to protect the guanidine adjuvant of the invention against hydrolysis in aqueous media.

Preferably, R is H, C₁-C₆-alkyl, C₁-C₆-alkenyl, C₁-C₆-alkynyl, C₇-C₂₀-alkylaryl, C₅-C₁₀-aryl, or —COR′, wherein R′ is C₁-C₆-alkyl or coumaryl.

More preferably, R is H, C₁-C₅-alkyl, C₁-C₅-alkenyl, C₁-C₅-alkynyl, C₇-C₁₃-alkylaryl, C₅-C₁₀-aryl, or —COR′, wherein R′ is C₁-C₅-alkyl or coumaryl.

In a most preferred embodiment, the at least one guanidine adjuvant comprised in the biocidal compositions of the invention is a guanidine derivative of formula (I) wherein R is H, C₁-C₄-alkyl, or —COR′, wherein R′ is C₁-C₄-alkyl or coumaryl.

In a specific embodiment, the at least one guanidine adjuvant comprised in the biocidal compositions of the invention is a guanidine derivative of formula (I) wherein R is H, methyl, ethyl, n-propyl, iso-propyl, n-butyl, sec-butyl, tert-butyl, acetyl, pivaloyl or coumaryl.

In a more specific embodiment, the at least one guanidine adjuvant comprised in the biocidal compositions of the invention is a guanidine derivative of formula (I) wherein R is H, n-propyl, iso-propyl, tert-butyl, acetyl or pivaloyl.

In a most specific embodiment, the at least one guanidine adjuvant comprised in the biocidal compositions of the invention is a guanidine derivative of formula (I) wherein R is H.

Specific and preferred embodiments for the guanidine adjuvant of formula (I) are 1,1,3,3-tetramethylguanidine (TMG) and 2-tert-butyl-1,1,3,3-tetramethylguanidine, more preferably, the guanidine adjuvant of formula (I) is 1,1,3,3-tetramethylguanidine.

The guanidine adjuvant according to the invention may be in the form of a free base, or in the form of a salt, or the guanidine adjuvant is present in the form of both, a salt of the guanidine of the formula (I) as well as the guanidine of the formula (I) as a free base.

If the guanidine adjuvant of formula (I) is in the form of a salt, it usually comprises a guanidinium cation and an anionic counterion. Suitable anionic counterions are known to the skilled artisan and may be derived from an inorganic acid or an organic acid, for example, chloride, sulfate, acetate or carboxylate anions derived from fatty acids, such as octanoic acid, decanoic acid or dodecanoic acid. Preferably, the anionic counterion is derived from an inorganic acid.

In the biocidal compositions of the invention, the relative amounts of the at least one 4-isothiazolin-3-one biocidal active compound and the at least one guanidine adjuvant may vary depending on, e.g., the nature of the biocidal active compound and the nature of the guanidine adjuvant. Advantageously, however, the weight ratio of the guanidine adjuvant to the 4-isothiazolin-3-one biocidal active compound is from about 200:1 to 1:1, preferably from about 100:1 to 1:1, more preferably from about 50:1 to 2:1, even more preferably from about 20:1 to 4:1, and most preferably from about 10:1 to 5:1.

In a preferred biocidal composition of the invention, the weight ratio of the guanidine adjuvant to BIT as 4-isothiazolin-3-one biocidal active compound is from about 200:1 to 1:1, preferably from about 100:1 to 1:1, more preferably from about 50:1 to 2:1, even more preferably from about 40:1 to 5:1 and most preferably from about 20:1 to 5:1.

In another preferred biocidal composition of the invention, the weight ratio of the guanidine adjuvant to BBIT as 4-isothiazolin-3-one biocidal active compound is from about 200:1 to 1:1, preferably from about 100:1 to 1:1, more preferably from about 80:1 to 5:1, and most preferably from about 40:1 to 5:1.

In a further preferred biocidal composition of the invention, the 4-isothiazolin-3-one biocidal active compound is a mixture of BIT and BBIT, wherein the weight ratio of the guanidine adjuvant to BIT is from about 100:1 to 1:1 and the weight ratio of guanidine adjuvant to BBIT is from about 200:1 to 1:1, preferably, wherein the weight ratio of guanidine adjuvant to BIT is from about 50:1 to 2:1 and the weight ratio of guanidine adjuvant to BBIT is from about 100:1 to 1:1, more preferably, wherein the weight ratio of guanidine adjuvant to BIT is from about 40:1 to 5:1, and the weight ratio of guanidine adjuvant to BBIT is from about 80:1 to 5:1 and most preferably, wherein the weight ratio of guanidine adjuvant to BIT is from about 20:1 to 5:1 and the weight ratio of guanidine adjuvant to BBIT is from about 40:1 to 5:1.

In a specific biocidal composition of the invention, the guanidine adjuvant is 1,1,3,3-tetramethyl guanidine (TMG) and the 4-isothiazolin-3-one biocidal active compound is BIT, wherein the weight ratio of TMG to BIT is from about 200:1 to 1:1, preferably from about 50:1 to 2:1, more preferably from about 40:1 to 5:1 and most preferably from about 20:1 to 5:1.

In another specific biocidal composition of the invention, the guanidine adjuvant is TMG and the 4-isothiazolin-3-one biocidal active compound is BBIT, wherein the weight ratio of TMG to BBIT is from about 200:1 to 1:1, preferably from about 100:1 to 1:1, more preferably from about 80:1 to 5:1, and most preferably from about 40:1 to 5:1.

In a further specific biocidal composition of the invention, the 4-isothiazolin-3-one biocidal active compound is a mixture of BIT and BBIT and the guanidine adjuvant is TMG, wherein the weight ratio of the TMG to BIT is from about 100:1 to 1:1 and the weight ratio of TMG to BBIT is from about 200:1 to 1:1, preferably wherein the weight ratio of TMG to BIT is from about 50:1 to 2:1 and the weight ratio of TMG to BBIT is from about 100:1 to 1:1, more preferably, wherein the weight ratio of TMG to BIT from about 40:1 to 5:1, and the weight ratio of TMG to BBIT is from about 80:1 to 5:1 and most preferably, wherein the weight ratio of the TMG to BIT is from about 20:1 to 5:1 and the weight ratio of TMG to BBIT is from about 40:1 to 5:1.

As used herein, relative ratios or weight ratios refer to weight per weight (w/w) ratios. When a w/w ratio is disclosed herein for salts, such as guanidinium salts, it is calculated with respect to the free base, e.g. to the guanidinium moiety of a guanidinium salt. This means that the molecular weight of the counterion to the guanidinium cation is not taken into account when the relative ratio is calculated. Parts per million (ppm) as used herein, similarly refers to weight per weight ratios, i.e. 1 ppm means 1×10⁻⁶, or 0.000001, or 0.0001% per weight.

The biocidal compositions of the invention are particularly effective against bacteria and fungi. Exemplary microorganisms are
Bacteria:
Alcaligenes such as Alcaligenes faecalis, Acinetobacter such as Acinetobacter calcoaceticus, Bacillus such as Bacillus subtilis, Citrobacter such as Citrobacter freundii, Corynebacterium such as Corynebacterium ammoniagenes, Enterobacter such as Enterobacter aerogenes or Enterobacter cloacae, Enterococcus such as Enterococcus hirae, Escherichia such as Escherichia coli, Proteus such as Proteus hauseri, Pseudomonas such as Pseudomonas aeruginosa, Pseudomonas fluorescens or Pseudomonas stutzeri, Salmonella such as Salmonella enterica, Staphylococcus such as Staphylococcus aureus;
Fungi:
Acremonium such as Acremonium strictum, Alternaria such as Alternaria tenuis or Alternaria alternata, Aspergillus such as Aspergillus niger or Aspergillus brasiliensis, Candida such as Candida albicans, Chaetomium such as Chaetomium globosum, Fusarium such as Fusarium solani, Geotrichum such as Geotrichum candidum, Lentinus such as Lentinus tigrinus, Penicillium such as Penicillium glaucum, Penicillium funiculosum or Penicillium pinophilum, Rhodotorula such as Rhodotorula rubra or Rhodotorula mucilaginosa, Stachybotrys such as Stachybotrys chartarum, Trichoderma such as Trichoderma virens.

The biocidal composition of the invention may comprise further biocidal active compounds. Examples of such further biocidal active compounds are bronopol, benzyl hemiformal, tetramethylazodicarboxamide (TMAD), 1,3-bis(hydroxymethyl)-5,5-dimethylimidazolidine-2,4-dione (DMDMH), tris-hydroxymethyl nitromethane (THNM), dimethyl oxazolidine (DMO), p-chloro-m-cresol, dimethylol urea, 1,2-dibromo-2,4-dicyanobutane, 2,2-dibromo-3-nitrilopropionic acid amide, glutaric dialdehyde, ethylene glycol hemiformal, ethylenglykol-bis-hemiformal, N-methylol urea, bis(tetrakis hydroxymethyl) phosphonium sulfate (THPS), thiabendazol, carbendazim, zinc pyrithione, sodium pyrithione, potassium pyrithione, lithium pyrithione, ammonium pyrithione, calcium pyrithione, magnesium pyrithione, an organic amine pyrithione, barium pyrithione, strontium pyrithione, copper pyrithione, cadmium pyrithione, 2-phenoxyethanol, phenoxypropanol, o-phenyl-phenol, benzyl alcohol, sodium dithiocarbamates, chlorophen, quarternary ammonium salts, such as N-alkyl-N,N-dimethyl-benzyl-ammonium chloride, or tri-n-butyl tetradecyl phosponium chloride, C₈-C₁₆ alkyl amines, and organic acids such as benzoic acid, dehydroacetic acid, sorbic acid, salicylic acid.

It is, however, preferred that the biocidal composition of the invention comprises no further biocidal active compounds. In particular, the biocidal compositions of the invention are able to satisfy preservative efficacy requirements without employing pyrithione or pyrithione salts such as the ones listed above.

The biocidal compositions of the invention have numerous applications and can be used in any suitable industry or field. The biocidal compositions of the invention may be in the form of a solution, an emulsion, a suspension, a dust, a powder, a foam, a paste, a granulate material, a resin or microencapsulated in polymeric materials. The formulation type depends on the particular intended purpose and should, in general, ensure a fine and uniform distribution of the biocidal composition according to the invention.

For instance, the biocidal compositions can be used in the paint and coating industry, the construction-chemistry field, the polymer-chemistry field, the mineral-oil industry, the textile industry or in the photochemical industry, etc. The degree of increase in biocidal activity seen for the biocidal active compound in the biocidal compositions of the invention also renders the biocidal compositions potentially useful as disinfectants. The biocidal compositions are particularly useful for in-can or dry-film preservation, or for the treatment of industrial process water.

The biocidal compositions of the invention may be added to a product or locus in or on which microorganisms are to be controlled. The biocidal active compound and the guanidine adjuvant may be in the form of a concentrate comprising its essential ingredients, i.e., the at least one 4-isothiazolin-3-one biocidal active compound and the at least one guanidine adjuvant of formula (I) (“biocidal concentrate”), which can then be added to said product. The concentrate may also be diluted with or suspended, dissolved or emulsified in a suitable solvent or carrier before being added to the product. The addition of the biocidal composition to the product to be protected results in a “biocidal product”.

Thus, the invention further provides a “biocidal product” comprising the biocidal composition according to the invention.

In the biocidal product, the at least one 4-isothiazolin-3-one biocidal active compound and the at least one guanidine adjuvant are present in a biocidal effective amount. The amounts of the at least one 4-isothiazolin-3-one biocidal active compound and of the at least one guanidine adjuvant in the biocidal product can vary based on different factors, such as the biocidal active compound or the guanidine adjuvant used.

The biocidal product advantageously comprises the biocidal composition of the invention in an amount so that the at least one 4-isothiazolin-3-one biocidal active compound is present in the biocidal product in an amount of from about 1 to 500 ppm, about 1 to 400 ppm, about 1 to 300 ppm, about 1 to 200 ppm, about 1 to 150 ppm, about 1 to 100 ppm, or about 1 to 50 ppm, or about 1 to 25 ppm. Preferably, the at least one 4-isothiazolin-3-one biocidal active compound is present in said biocidal product in an amount of from about 1 to 200 ppm, about 1 to 150 ppm, about 1 to 100 ppm, or about 1 to 50 ppm, or about 1 to 25 ppm. Most preferably, the at least one 4-isothiazolin-3-one biocidal active compound is present in the biocidal product in an amount of from about 1 to 100 ppm, or from about 1 to 50 ppm.

In a preferred embodiment, the biocidal product comprises a biocidal composition as defined above, wherein the at least one 4-isothiazolin-3-one biocidal active compound is BIT or BBIT or a mixture thereof, wherein BIT is present in an amount of from about 1 to 100 ppm and/or BBIT is present in an amount of from about 1 to 130 ppm. Preferably, BIT is present in the biocidal product in an amount of from about 1 to 90 ppm, about 5 to 80 ppm, about 10 to 70 ppm or about 20 to 60 ppm, or about 10 ppm, about 20 ppm, about 30 ppm, about 40 ppm, about 50 ppm or about 60 ppm, and/or BBIT is present in an amount from about 10 to 130 ppm, about 20 to 120 ppm, about 30 to 110 ppm, about 40 to 100 ppm, about 50 to 100 ppm, about 60 to 100 ppm, about 70 to 100 ppm, about 80 to 100 ppm, about 90 to 100 ppm, or about 25 ppm, about 40 ppm, about 50 ppm, about 60 ppm, about 70 ppm, about 80 ppm, about 90 ppm, about 100 ppm or about 110 ppm. Most preferably, BIT is present in the biocidal product in an amount of about 10 ppm, about 20 ppm, or of about 50 ppm, and/or BBIT is present in an amount of about 25 ppm, about 50 ppm or of about 100 ppm.

The ratios of the at least one 4-isothiazolin-3-one biocidal active compound and of the at least one guanidine adjuvant in the biocidal product are the same as the ratios of these components in the biocidal composition according to the present invention.

Accordingly, the guanidine adjuvant is present in said biocidal product in an amount of from about 500 to 1000 ppm, about 500 to 990 ppm, about 500 to 980 ppm, about 500 to 970 ppm, about 500 to 960 ppm, about 500 to 950 ppm, about 500 to 940 ppm, or about 500 ppm, about 690 ppm, about 750 ppm, about 800 ppm, about 810 ppm, about 820 ppm, about 830 ppm, about 840 ppm, about 850 ppm, about 860 ppm, about 870 ppm, about 880 ppm, about 890 ppm, about 900 ppm, about 910 ppm, about 920 ppm, about 930 ppm, about 940 ppm, about 950 ppm, about 960 ppm, about 970 ppm or about 980 ppm. Preferably, the guanidine adjuvant is present in an amount of from about 500 to 940 ppm, more preferably of from about 820 to 950 ppm, and most preferably of from about 830 to 940 ppm.

In a specific embodiment, the biocidal product comprises a biocidal composition as defined above, wherein the 4-isothiazolin-3-one biocidal active compound is BIT, which is present in the biocidal product in an amount of from about 10 to 90 ppm, and the guanidine adjuvant is TMG, which is present in the biocidal product in an amount of from about 500 to 990 ppm, preferably wherein BIT is present in the biocidal product in an amount of from about 20 to 80 ppm and TMG is present in the biocidal product in an amount of from about 700 to 980 ppm; more preferably wherein BIT is present in the biocidal product in an amount of from about 30 to 70 ppm and TMG is present in the biocidal product in an amount of from about 800 to 970 ppm, and most preferably wherein BIT is present in the biocidal product in an amount of from about 40 to 60 ppm; and TMG is present in the biocidal product in an amount of from about 900 to 950 ppm.

In another specific embodiment, the biocidal product comprises a biocidal composition as defined above, wherein the 4-isothiazolin-3-one biocidal active compound is BBIT, which is present in the biocidal product in an amount of from about 5 to 140 ppm and the guanidine adjuvant is TMG, which is present in the biocidal product in an amount of from about 200 to 970 ppm, preferably wherein BBIT is present in the biocidal product in an amount of from about 10 to 130 ppm and TMG is present in the biocidal product in an amount of from about 300 to 950 ppm; more preferably wherein BBIT is present in the biocidal product in an amount of from about 15 to 120 ppm and TMG is present in the biocidal product in an amount of from about 400 to 930 ppm, and most preferably wherein BBIT is present in the biocidal product in an amount of from about 20 to 110 ppm and TMG is present in the biocidal product in an amount of from about 500 to 910 ppm.

In another specific embodiment, the biocidal product comprises a biocidal composition as defined above, wherein the 4-isothiazolin-3-one biocidal active compound is a mixture of BIT and BBIT, and the guanidine adjuvant is TMG, wherein in the biocidal active compound BIT is present in an amount of from about 10 to 90 ppm, BBIT is present in an amount of from about 5 to 140 ppm and TMG is present in an amount of from about 200 to 970 ppm; preferably wherein BIT is present in the biocidal product in an amount of from about 20 to 80 ppm, BBIT is present in an amount of from about 10 to 130 ppm and TMG is present in an amount of from about 300 to 950 ppm; more preferably wherein BIT is present in an amount of from about 30 to 70 ppm, BBIT is present in an amount of from about 15 to 120 ppm and TMG is present in an amount of from about 400 to 930 ppm; and most preferably wherein BIT is present in the biocidal product in an amount of from about 40 to 60 ppm, BBIT is present in an amount of from about 20 to 110 ppm, and TMG is present in an amount of from about 500 to 910 ppm.

The “biocidal product” may be a product selected from the group consisting of a paint, a coating, a sealant, a plaster, a starch solution, an aqueous mineral slurry, a dispersion, a caulk, a slurry of colored pigments, a slurry of inorganic fillers and colored pigments, a construction-chemical product, a glue or adhesive, a polymer dispersion, an emulsion polymer, a detergent or cleaner, a mineral oil or mineral oil product, a cooling lubricant, an auxiliary for leather and/or textile and/or photochemical industry, a pre-product or intermediate of the chemical industry, a wax and/or clay emulsion, an ink, a wash and a disinfectant.

Preferably, the biocidal product may be a product selected from the group consisting of a paint, a coating, an emulsion polymer or an aqueous mineral slurry. More preferably, the biocidal product is a product selected from the group consisting of a paint and a coating.

The biocidal compositions of the invention provide their most advantageous biocidal efficacy in aqueous solvent systems. Accordingly, the biocidal products of the invention are preferably aqueous products.

The pH of the biocidal compositions or of the biocidal products of the invention may vary over a considerable range. Preferably, the pH of the biocidal compositions as well as of the biocidal products of the invention is above about 5.0, about 5.5, about 6.0, about 6.5, about 7.0, about 7.5, about 8.0, or about 8.5. More preferably, the pH is above about 7.0, about 7.5, about 8.0, or about 8.5. Most preferably, the pH is above about 8.5 and below 12.0. In advantageous embodiments, the biocidal compositions or biocidal products comprise a buffering agent. Suitable buffering agents are known in the art. Generally, increased hydrolysis (i.e. reduced chemical stability) of the guanidine adjuvants of the invention is observed under acidic conditions (i.e. a pH below about 7.0).

The invention also provides a method for inhibiting the growth of bacteria and fungi in a locus subject or susceptible to contamination by bacteria and fungi, which comprises incorporating into or onto the locus in an amount which is effective to adversely affect the growth of bacteria and fungi the biocidal composition according to the invention. Generally, the locus may be a place or locality, a surface, a material, a plant or a facility.

Generally, the inventors have surprisingly found that guanidine adjuvants enhance the biocidal activity of 4-isothiazolin-3-one biocidal active compounds. Accordingly, the invention also provides the use of at least one guanidine adjuvant for enhancing the biocidal activity of at least one 4-isothiazolin-3-one biocidal active compound in a biocidal composition according to the invention as defined above.

The present invention is further illustrated but not limited by the following examples.

### EXAMPLES

### Example 1: Bacterial and Fungal Challenge Testing of Individual 4-isothiazolin-3-One Biocidal Active Compounds and Guanidine Adjuvants

The following bacterial and fungal challenge tests were performed to ascertain whether low concentrations of 4-isothiazolin-3-one biocidal active compounds, pyrithione, coumarin or guanidine adjuvant are sufficient to prevent microbial contamination of final products when deliberately inoculated with spoilage microbes.

The tests were performed according to ASTM standard D2574-97 (Standard Test Method for Resistance of Emulsion Paints in the Container to Attack by Microorganisms, ASTM International, West Conshohocken, Pa.), with higher inoculation volumes and frequency. A standard water based interior paint was used as the test substrate. Sample sizes of 20 g test substrate were used and the test samples were prepared in a sterile 30 mL square Nalgene bottle.

Preparation of Test Inocula

The bacteria were grown on pH 5, 7, or 9 Trypticase Soy Agar (TSA) lawns. The bacteria were grown individually on TSA and harvested by using sterile buffered water. The bacterial lawns were washed off with 30 mL of sterile water and an equal volume of each individual cell suspension was withdrawn from each serum bottle to make a combined cell suspension. Combined bacterial suspension were about 10⁷ cfu/mL, which provides about 10⁶ cfu/mL in the sample.

Fungal lawns were grown on Potato Dextrose Agar (PDA) or Sabouraud Dextrose Agar (SAB). Individual fungal spore suspensions were harvested by adding 10 mL of sterile 0.05% Triton X to fungal lawns. The lawns were then gently agitated by rubbing a sterile swab on the lawn, being careful not to puncture the agar. The liquid was then aseptically transferred to a sterile bottle containing sterile glass beads. The top of the bottle was closed and the bottle shaken vigorously to break up any chunks in the suspension. The shaken spore suspension was decanted through sterile fibers into another sterile bottle. The decanted spore suspension was counted using a hemocytometer. Once the spore counts were determined, each suspension was diluted in order to obtain 10⁶ spore/mL. Each diluted fungal suspension was poured into a sterile container.

The following microorganisms were used for inoculation of the tested samples:

Test Inoculum—Bacteria

| Organism | ATCC# |
|---|---|
| Acinetobacter calcoaceticus | 14987 |
| Escherichia coli | 11229 |
| Pseudomonas aeruginosa | 10145 |
| Enterobacter cloacae | 7256 |

Test Inoculum—Fungi

| Organism | ATCC# |
|---|---|
| Aspergillus niger | 6275 |
| Penicillium funiculosum | 11797 |
| Candida albicans | 10231 |

Sample Inoculation and Monitoring

For the bacterial challenge testing, each sample was inoculated with a combined bacterial test inoculum volume equivalent to 10% of the total initial sample volume for the initial inoculation, 5% of the total initial sample volume for the second inoculation and 2.5% of the total initial sample volume for the third inoculation. Inoculum volumes for the fungal challenge tests were 2%, 1% and 0.5% of the total initial sample volume, respectively. Samples were inoculated every 96 h.

Concentrations of biocidal active compounds and adjuvants refer to the final concentration in the test samples prior to the first inoculation.

The efficacy of the added agent in each sample was monitored by means of a streak plate test after 24 hours (all inoculations) and 72 hours of inoculation (first and second inoculation). At 72 hours of the third inoculation performed, a dilution plate count was performed in order to obtain a quantitative measurement of contamination (cfu/mL). A count of less than 10 colony forming units per mL (>10 cfu/mL) is considered to show no measurable contamination. For the streak plate tests, bacterial samples were streaked on Tryptic Soy Agar (TSA) and incubated for 48 hours at 30° C. before reading. Fungal samples were streaked on Potato Dextrose Agar (PDA) and incubated for 5 days at 25° C. before reading.

Streak Plate Reading

The streak plates were ranked from 0-5c according to the degree of microbial growth:

| | |
|---|---|
| 0 = no growth | |
| 1 = 1-5 Colony Forming Unit (cfu) | Very lightly contaminated |
| 2 = 6-15 cfu | Lightly contaminated |
| 3 = 16-30 cfu | Moderately contaminated |
| 4 = 31-45 cfu | Heavily contaminated |
| 5 = greater than 45 cfu | Severely contaminated |
| 5c = Confluent Growth | Very Severely contaminated |

TABLE 1

| | | | 1^{st} inoculation | | 2^{nd} inoculation | | 3^{rd} inoculation | |
|---|---|---|---|---|---|---|---|---|
| Bacterial Challenge Test | | | 10% | | 5% | | 2.50% | |
| Sample | Composition | ppm | 24 h | 72 h | 24 h | 72 h | 24 h | 72 h |
| 1 | Negative Control | 0 | 5c | 5c | N/A | 5c | 5c | 1.7 × 10⁶ |
| 2 | BIT | 50 | 5 | 4 | N/A | 5 | 5 | 4.2 × 10⁷ |
| 3 | NaPT | 80 | 5c | 5c | N/A | 5c | 5c | 2.2 × 10⁷ |
| 4 | BBIT | 25 | 5c | 5c | N/A | 5c | 5c | 8.3 × 10⁶ |
| 5 | BBIT | 50 | 5c | 5c | N/A | 5c | 5c | 6.0 × 10⁶ |
| 6 | BBIT | 100 | 5c | 5c | N/A | 5c | 5c | 5.6 × 10⁶ |
| 7 | TMG | 750 | 5 | 5c | N/A | 5c | 5c | 1.7 × 10⁵ |
| 8 | TMG | 1000 | 5 | 5 | N/A | 5c | 5c | 2.1 × 10⁶ |
| 9 | TMG | 1250 | 0 | 0 | N/A | 5c | 5c | 6.6 × 10⁶ |
| 10 | TMG | 1500 | 0 | 0 | N/A | 0 | 3 | <10 |
| 11 | Coumarin | 500 | 5c | 5c | N/A | 5c | 5c | 3.5 × 10⁶ |

The bacterial challenge tests show that when used individually at low concentrations, neither 1,2-benzisothiazolin-3-one (BIT), N-(n-butyl)-1,2-benzisothiazolin-3-one (BBIT), sodium pyrithione (NaPT) or 1,1,3,3-tetramethylguanidine (TMG) exhibit significant sufficient bacterial bactericidal efficacy. Coumarin, which may also be used as an adjuvant in biocidal compositions, similarly exhibited no bactericidal activity.

TABLE 2

| | | | 1^{st} inoculation | | 2^{nd} inoculation | | 3^{rd} inoculation | |
|---|---|---|---|---|---|---|---|---|
| Fungal Challenge Test | | | 2% | | 1% | | 0.50% | |
| Sample | Composition | ppm | 24 h | 72 h | 24 h | 72 h | 24 h | 72 h |
| 1 | Negative Control | 0 | 4 | 3 | N/A | 3 | 3 | 3.8 × 10² |
| 2 | BIT | 50 | 5 | 2 | N/A | 1 | 5 | 2.0 × 10² |
| 3 | NaPT | 80 | 0 | 0 | 0 | 0 | 0 | <10 |
| 4 | BBIT | 25 | 4* | 1* | N/A | 0 | 2 | 1.0 × 10¹ |
| 5 | BBIT | 50 | 3* | 1* | N/A | 0 | 1 | <10 |
| 6 | BBIT | 100 | 4* | 1* | N/A | 0 | 1 | <10 |
| 7 | TMG | 750 | 4 | 0 | N/A | 1** | 3 | <10 |
| 8 | TMG | 1000 | 4 | 0 | N/A | 0** | 3 | <10 |
| 9 | TMG | 1250 | 2 | 0 | N/A | 0** | 3 | <10 |
| 10 | TMG | 1500 | 2 | 0 | N/A | 0** | 3 | <10 |
| 11 | Coumarin | 500 | 3 | 3 | N/A | 2 | 4 | 1.1 × 10² |

*Inoculum added was 5%/
**Inoculum added was 2%

In the fungal challenge tests, no individual compound provided complete inhibition of fungal growth when used at the low test concentrations.

### Example 2: Bacterial and Fungal Challenge Testing of Formulations Comprising Combinations of 4-isothiazolin-3-one Biocidal Active Compounds and Guanidine Adjuvant

Further challenge testing was performed using combinations of 4-isothiazolin-3-one biocidal active compounds BIT and BBIT together with the guanidine adjuvant TMG to assess whether guanidine adjuvants are capable of enhancing the biocidal activity of 4-isothiazolin-3-one biocidal active compounds.

The challenge tests were performed as described above.

TABLE 3

| | | | 1^{st} inoculation | | 2^{nd} inoculation | | 3^{rd} inoculation | |
|---|---|---|---|---|---|---|---|---|
| Bacterial Challenge Test | | | 10% | | 5% | | 2.50% | |
| Sample | Composition | ppm | 24 h | 72 h | 24 h | 72 h | 24 h | 72 h |
| 1 | BIT | 50 | 0 | 0 | 0 | 0 | 0 | <10 |
| | TMG | 940 | | | | | | |
| 2 | BIT | 20 | 0 | 0 | 0 | 0 | 0 (1) | <10 |
| | TMG | 750 | | | | | | |
| | NaPT | 80 | | | | | | |
| 3 | BIT | 10 | 0 | 0 | 0 | 0 | 5 | 2.2 × 10³ |
| | TMG | 790 | | | | | | |
| | NaPT | 80 | | | | | | |
| 4 | BIT | 50 | 0 | 0 | N/A | 0 | 0 | <10 |
| | TMG | 830 | | | | | | |
| | BBIT | 100 | | | | | | |
| 5 | BIT | 50 | 0 | 0 | N/A | 0 | 0 | <10 |
| | TMG | 880 | | | | | | |
| | BBIT | 50 | | | | | | |
| 6 | BIT | 50 | 0 | 0 | N/A | 0 | 0 | <10 |
| | TMG | 910 | | | | | | |
| | BBIT | 25 | | | | | | |
| 7 | BIT | 50 | 0 | 0 | N/A | 0 | 0 | <10 |
| | TMG | 750 | | | | | | |
| | BBIT | 50 | | | | | | |
| 8 | BIT | 50 | 0 | 0 | N/A | 0 | 0 | <10 |
| | TMG | 500 | | | | | | |
| | BBIT | 25 | | | | | | |
| 9 | BIT | 50 | 0 | 0 | N/A | 0 | 0 | <10 |
| | TMG | 690 | | | | | | |
| | Coumarin | 100 | | | | | | |

The bacterial challenge tests show that the guanidine adjuvant TMG significantly improved the bactericidal activity of BIT and BBIT compared to the 4-isothiazolin-3-one biocidal active compounds alone when used at similar concentrations. This effect is observed with and without sodium pyrithione (NaPT).

TABLE 4

| | | | 1^{st} inoculation | | 2^{nd} inoculation | | 3^{rd} inoculation | |
|---|---|---|---|---|---|---|---|---|
| Fungal Challenge Test | | | 2% | | 1% | | 0.50% | |
| Sample | Composition | ppm | 24 h | 72 h | 24 h | 72 h | 24 h | 72 h |
| 1 | BIT | 50 | 3 | 0 | N/A | 0** | 3 | <10 |
| | TMG | 940 | | | | | | |
| 2 | BIT | 20 | 0 | 0 | 0** | 0** | 0 | <10 |
| | TMG | 750 | | | | | | |
| | NaPT | 80 | | | | | | |
| 3 | BIT | 10 | 0 | 0 | 0 | 0 | 0 | <10 |
| | TMG | 790 | | | | | | |
| | NaPT | 80 | | | | | | |
| 4 | BIT | 50 | 0* | 0* | N/A | 0 | 0 | <10 |
| | TMG | 830 | | | | | | |
| | BBIT | 100 | | | | | | |
| 5 | BIT | 50 | 0* | 0* | N/A | 0 | 0 | <10 |
| | TMG | 880 | | | | | | |
| | BBIT | 50 | | | | | | |
| 6 | BIT | 50 | 1* | 0* | N/A | 0 | 0 | <10 |
| | TMG | 910 | | | | | | |
| | BBIT | 25 | | | | | | |
| 7 | BIT | 50 | 0* | 0* | N/A | 0 | 0 | <10 |
| | TMG | 750 | | | | | | |
| | BBIT | 50 | | | | | | |
| 8 | BIT | 50 | 2* | 0* | N/A | 0 | 1 | <10 |
| | TMG | 500 | | | | | | |
| | BBIT | 25 | | | | | | |
| 9 | BIT | 50 | 2 | 0 | N/A | 0 | 2 | <10 |
| | TMG | 690 | | | | | | |
| | Coumarin | 200 | | | | | | |

*Inoculum added was 5%/
**Inoculum added was 2%

As shown above, TMG had an enhancing effect on the fungicidal activity of BIT and BBIT. This effect was observed with, or without sodium pyrithione.

TABLE 5

| | | | 1^{st} inoculation | | 2^{nd} inoculation | | 3^{rd} inoculation | |
|---|---|---|---|---|---|---|---|---|
| Bacterial Challenge Test | | | 10% | | 5% | | 2.50% | |
| Sample | Composition | ppm | 24 h | 72 h | 24 h | 72 h | 24 h | 72 h |
| 1 | Negative Control | 0 | 5c | 5c | N/A | 5c | 5c | 5.6 × 10⁶ |
| 2 | Negative Control | 0 | 5c | 5c | N/A | 5c | 5c | 1.3 × 10⁶ |
| 3 | Negative Control | 0 | 5c | 5c | N/A | 5c | 5c | 1.5 × 10⁷ |
| 4 | BIT 5% | 1000 | 0 | 0 | N/A | 0 | 0 | <10 |
| [formulation 126] | BBIT 10% | | | | | | | |
| | TMG 83% | | | | | | | |
| 5 | BIT 5% | 1000 | 0 | 0 | N/A | 0 | 0 | <10 |
| [formulation 126] | BBIT 10% | | | | | | | |
| | TMG 83% | | | | | | | |
| 6 | BIT 5% | 1000 | 0 | 0 | N/A | 0 | 0 | <10 |
| [formulation 126] | BBIT 10% | | | | | | | |
| | TMG 83% | | | | | | | |
| 7 | BIT 2.5% | 1000 | 5c | 5c | N/A | 5c | 5c | 1.5 × 10⁷ |
| [formulation 165] | Dodecylguanidine HCl | | | | | | | |
| | 22.5% | | | | | | | |
| 8 | BIT 2.5% | 1000 | 5c | 5c | N/A | 5c | 5c | 3.0 × 10⁶ |
| [formulation 165] | Dodecylguanidine HCl | | | | | | | |
| | 22.5% | | | | | | | |
| 9 | BIT 2.5% | 1000 | 5c | 5c | N/A | 5c | 5c | 9.9 × 10⁶ |
| [formulation 165] | Dodecylguanidine HCl | | | | | | | |
| | 22.5% | | | | | | | |
| 10 | BIT 5% | 1000 | 5 | 5 | N/A | 0 | 2 | 3.0 × 10² |
| [formulation 166] | TMG 40% | | | | | | | |
| 11 | BIT 5% | 1000 | 5 | 5 | N/A | 0 | 1 | 6.2 × 10³ |
| [formulation 166] | TMG 40% | | | | | | | |
| 12 | BIT 5% | 1000 | 5 | 4 | N/A | 0 | 2 | 4.5 × 10³ |
| [formulation 166] | TMG 40% | | | | | | | |
| 13 | BIT 5% | 1000 | 5c | 5c | N/A | 5 | 5 | 3.3 × 10⁶ |
| [formulation 167] | Methylguanidine HCl | | | | | | | |
| | 40% | | | | | | | |
| 14 | BIT 5% | 1000 | 5c | 5c | N/A | 5 | 5 | 1.0 × 10⁷ |
| [formulation 167] | Methylguanidine HCl | | | | | | | |
| | 40% | | | | | | | |
| 15 | BIT 5% | 1000 | 5c | 5c | N/A | 5 | 5 | 2.6 × 10⁷ |
| [formulation 167] | Methylguanidine HCl | | | | | | | |
| | 40% | | | | | | | |
| 16 | BIT 5% | 1000 | 5c | 5c | | | | |
| [formulation 169] | N,N-dihexylguanidine HI | | | | | | | |
| | 40% | | | | | | | |
| 17 | BIT 5% | 1000 | 5c | 5c | | | | |
| [formulation 169] | N,N-dihexylguanidine HI | | | | | | | |
| | 40% | | | | | | | |
| 18 | BIT 5% | 1000 | 5c | 5c | | | | |
| [formulation 170] | BBIT 5% | | | | | | | |
| | N,N-dihexylguanidine HI | | | | | | | |
| | 83% | | | | | | | |
| 19 | BIT 5% | 1000 | 5c | 5c | | | | |
| [formulation 170] | BBIT 5% | | | | | | | |
| | N,N-dihexylguanidine HI | | | | | | | |
| | 83% | | | | | | | |

The results of the bacterial challenge tests depicted in Table 5 show that the guanidine adjuvants of the invention (e.g., TMG) significantly improved the bactericidal activity of 4-isothiazolin-3-ones. This effect is not achieved with other guanidines (e.g., dodecylguanidine HCl, methylguanidine HCl or N,N-dihexylguanidine HI).

TABLE 6

| | | | 1^{st} inoculation | | 2^{nd} inoculation | | 3^{rd} inoculation | |
|---|---|---|---|---|---|---|---|---|
| Fungal Challenge Test | | | 2.5% | | 1% | | 0.5% | |
| Sample | Composition | ppm | 24 h | 72 h | 24 h | 72 h | 24 h | 72 h |
| 1 | Negative Control | 0 | 5c | 5c | N/A | 3 | 5c | 1.0 × 10⁴ |
| 2 | Negative Control | 0 | 5c | 5c | N/A | 3 | 5c | 1.3 × 10⁴ |
| 3 | Negative Control | 0 | 5c | 5c | N/A | 2 | 5c | 1.5 × 10⁴ |
| 4 | BIT 5% | 1000 | 0 | 0 | N/A | 0 | 0 | <10 |
| [formulation 126] | BBIT 10% | | | | | | | |
| | TMG 83% | | | | | | | |
| 5 | BIT 5% | 1000 | 0 | 0 | N/A | 0 | 0 | <10 |
| [formulation 126] | BBIT 10% | | | | | | | |
| | TMG 83% | | | | | | | |
| 6 | BIT 5% | 1000 | 0 | 0 | N/A | 0 | 1 | <10 |
| [formulation 126] | BBIT 10% | | | | | | | |
| | TMG 83% | | | | | | | |
| 7 | BIT 2.5% | 1000 | 5c | 5 | N/A | 2 | 5c | 1.5 × 10⁴ |
| [formulation 165] | Dodecylguanidine HCl | | | | | | | |
| | 22.5% | | | | | | | |
| 8 | BIT 2.5% | 1000 | 5c | 5c | N/A | 2 | 5c | 1.5 × 10⁴ |
| [formulation 165] | Dodecylguanidine HCl | | | | | | | |
| | 22.5% | | | | | | | |
| 9 | BIT 2.5% | 1000 | 5c | 4 | N/A | 2 | 5c | 1.5 × 10⁴ |
| [formulation 165] | Dodecylguanidine HCl | | | | | | | |
| | 22.5% | | | | | | | |
| 10 | BIT 5% | 1000 | 5c | 5c | N/A | 2 | 5c | 1.3 × 10⁴ |
| [formulation 167] | Methylguanidine HCl | | | | | | | |
| | 40% | | | | | | | |
| 11 | BIT 5% | 1000 | 5c | 5c | N/A | 2 | 5c | 1.7 × 10⁴ |
| [formulation 167] | Methylguanidine HCl | | | | | | | |
| | 40% | | | | | | | |
| 12 | BIT 5% | 1000 | 5c | 5c | N/A | 3 | 5c | 1.9 × 10⁴ |
| [formulation 167] | Methylguanidine HCl | | | | | | | |
| | 40% | | | | | | | |

The results of the fungal challenge tests depicted in Table 6 show that the guanidine adjuvants of the invention (e.g., TMG) significantly improved the activity of 4-isothiazolin-3-ones. This effect is not achieved with other guanidines (e.g., dodecylguanidine HCl, methylguanidine HCl or N,N-dihexylguanidine HI).

### Example 3: Quick Kill Testing of Formulations Comprising Combinations of 4-isothiazolin-3-one Biocidal Active Compounds and Guanidine Adjuvants

An additional test was performed to analyze how quickly the tested biocidal compositions will recover a sample from microbial spoilage. For each sample, 20 g of a pre-contaminated standard interior paint formulation serving as a test substrate was weighed into a sterile container. All samples were contaminated with the bacterial test inoculum described above (10% of the of the total initial sample volume).

A dilution-plate count was performed on the untreated sample (0 hour time point) and a biocidal composition added aseptically to each sample. Subsequent to this treatment, further dilution-plate counts were performed at fixed time intervals (time points are given in hours) on each sample, including an untreated negative control. All samples were incubated at 30° C.±2° C.

Concentrations in ppm refer to final concentrations of the biocidal compositions in the test samples. The relative amounts of active compounds and adjuvant in the tested biocidal compositions were as indicated below:

TABLE 7

| Formulation 103 | 2% | BIT | Formulation 113 | 5% | BIT |
|---|---|---|---|---|---|
| | 8% | NaPT | | 94% | TMG |
| | 75% | TMG | | | |
| Formulation 122 | 5% | BIT | Formulation 123 | 5% | BIT |
| | 1% | BBIT | | 2.5% | BBIT |
| | 93.1% | TMG | | 91.6% | TMG |
| Formulation 124 | 5% | BIT | Formulation 134 | 5% | BIT |
| | 5% | BBIT | | 88.7% | TMG |
| | 89.1% | TMG | | | |
| Formulation 126 | 5% | BIT | Comparative | 1.5% | CMIT/MIT (3:1) |
| | 10% | BBIT | Composition B | | |
| | 83% | TMG | | | |
| Comparative | 2% | BIT | Comparative | 30% 2-Bromo-2- | |
| Composition A | 4% | NaPT | Composition D | nitropropan-1,3-diol | |
| Comparative | 4.5% | BIT | Comparative | 20% 2,2-Dibromo-3 | |
| Composition C | 55.0% 2,2′,2″- | | Composition E | nitrilopropionamide | |
| | (hexahydro-1,3,5- | | | | |
| | triazine-1,3,5-triyl)- | | | | |
| | triethanol (HHT) | | | | |
| Comparative | 2.5% | MIT | Comparative | 10% | MIT |
| Composition F | 2.5% | BIT | Composition G | 10% | BIT |

| | | | |
|---|---|---|---|
| Comparative | MIT | 4.5-10.5% | ZnPT |
| Composition H | dithio- | | |
| | methylbenzamide | | |

TABLE 8

| Sample | Sample | | | | | |
|---|---|---|---|---|---|---|
| # | Description | ppm | T0 | T4 | T8 | T24 |
| 1 | Negative Control | N/A | 4.65 × 10⁷ | 5.22 × 10⁷ | 3.96 × 10⁷ | 5.03 × 10⁷ |
| 2 | Formulation #103 | 1000 | N/A | 3.69 × 10⁷ | 7.5 × 10⁶ | 7.1 × 10⁵ |
| 3 | Formulation #113 | 1000 | N/A | 1.91 × 10⁵ | <10 | <10 |
| 4 | Formulation #122 | 1000 | N/A | 4.8 × 10⁶ | 1.18 × 10⁵ | 4.4 × 10² |
| 5 | Formulation #123 | 1000 | N/A | 8.7 × 10⁶ | 7.0 × 10⁴ | 2.9 × 10² |
| 6 | Formulation #124 | 1000 | N/A | 1.05 × 10⁶ | 8.0 × 10³ | <10 |
| 7 | Comparative | 1000 | N/A | 1.26 × 10⁷ | 2.41 × 10⁶ | 1.61 × 10⁵ |
| | Composition A | | | | | |
| 8 | Comparative | 2500 | N/A | 1.46 × 10⁴ | <10 | <10 |
| | Composition A | | | | | |
| 9 | Comparative | 1000 | N/A | 6.14 × 10⁷ | <10 | <10 |
| | Composition B | | | | | |
| 10 | Comparative | 1000 | N/A | 2.54 × 10⁵ | 4.8 × 10³ | <10 |
| | Composition C | | | | | |
| 11 | Comparative | 1000 | N/A | <10 | <10 | <10 |
| | Composition D | | | | | |
| 12 | Comparative | 1000 | N/A | <10 | <10 | <10 |
| | Composition E | | | | | |

The tests show that biocidal compositions comprising a combination of either BIT, or BIT and BBIT in low concentrations, together with a guanidine adjuvant (here TMG) exhibit a similar performance to known standard formulations comprising MIT, CMIT or other common biocidal compositions.

TABLE 9

| Sample | Sample | | | | | |
|---|---|---|---|---|---|---|
| # | Description | ppm | T0 | T4 | T8 | T24 |
| 1 | Negative Control | N/A | 2.23 × 10⁷ | 1.39 × 10⁷ | 2.07 × 10⁷ | 3.04 × 10⁷ |
| 2 | BIT | 50 | N/A | 1.15 × 10⁷ | 3.4 × 10⁶ | 9.4 × 10⁵ |
| 3 | TMG | 940 | N/A | 1.19 × 10⁷ | 1.02 × 10⁷ | 4.0 × 10⁶ |
| 4 | BIT + BBIT | 50 + 50 | N/A | 8.9 × 10⁶ | 3.4 × 10⁶ | 1.21 × 10⁶ |
| 5 | BIT + BBIT | 50 + 100 | N/A | 9.0 × 10⁶ | 3.4 × 10⁶ | 1.06 × 10⁶ |
| 6 | Formulation #113 | 1000 | N/A | 1.27 × 10⁶ | 8.1 × 10⁴ | <10 |
| 7 | Formulation #113 | 1000 | N/A | 1.61 × 10⁶ | 1.38 × 10⁵ | <10 |
| 8 | Formulation #126 | 1000 | N/A | 9.7 × 10⁵ | 5.5 × 10⁴ | 6.0 × 10¹ |
| 9 | Formulation #134 | 1000 | N/A | 2.48 × 10⁶ | 1.06 × 10⁵ | 1.7 × 10² |
| 10 | Comparative | 1000 | N/A | 3.70 × 10⁶ | 5.9 × 10⁵ | 7.9 × 10⁴ |
| | Composition A | | | | | |
| 11 | Comparative | 2500 | N/A | 4.3 × 10⁴ | <10 | <10 |
| | Composition A | | | | | |
| 12 | Comparative | 1000 | N/A | 2.7 × 10⁵ | 1.78 × 10⁴ | <10 |
| | Composition B | | | | | |
| 13 | Comparative | 1000 | N/A | 8.6 × 10⁶ | 6.9 × 10⁶ | 6.7 × 10⁴ |
| | Composition F | | | | | |
| 14 | Comparative | 1000 | N/A | 5.9 × 10⁶ | 2.9 × 10⁵ | <10 |
| | Composition G | | | | | |
| 15 | Comparative | 1000 | N/A | 5.1 × 10⁶ | 2.49 × 10⁵ | <10 |
| | Compostion H | | | | | |

As shown above, TMG markedly accelerated the recovery after bacterial contamination and significantly enhanced the activity of BIT and BIT+BBIT.

### Example 4: Comparative Minimum Biofilm Eradication Concentration (MBEC) Assay

MBEC assays were performed to test the efficacy of biocidal compositions of the invention against a bacterial biofilm. The test was performed based on an ASTM E2799-12 protocol (Standard Test Method for Testing Disinfectant Efficacy against Pseudomonas aeruginosa Biofilm using the MBEC Assay, ASTM International, West Conshohocken, Pa.). Pseudomonas aeruginosa (ATCC 9027) was used in the assay.

Quantitative MBEC results are reported as the mean logo reduction for each disinfectant/biocidal composition concentration. Increased logo fold reduction of the biofilm indicates higher efficacy as disinfectant. A logo fold reduction of 7.3 is regarded as a complete kill.

TABLE 10

| | | Concentration | |
|---|---|---|---|
| Formulation | Contains | (ppm) | Log reduction |
| Comparative | 2% BIT/4% NaPT | 1000 | 3.0 |
| Composition A | | | |
| Comparative | CMIT/MIT-1.5% | 1000 | 2.2 |
| Composition B | Total | | |
| Comparative | CMIT/MIT-1.5% | 1500 | 2.4 |
| Composition B | Total | | |
| 113 | 5% BIT/94% TMG | 1000 | 8.0 (complete |
| | | | kill) |
| 113 | 5% BIT/94% TMG | 1500 | 8.0 (complete |
| | | | kill) |
| 126 | 5% BIT/83% TMG/ | 1000 | 8.0 (complete |
| | 10% BBIT | | kill) |

The MBEC assay shows that formulations according to the invention exhibit a biocidal efficacy, which proves them useful also as disinfectants, and which is significantly improved over commercially available biocidal compositions comprising BIT/NaPT or CMIT/MIT. Formulations 113 and 126 are capable of complete biofilm eradication, comparable to common surface disinfectants.

1. A biocidal composition comprising
i) at least one 4-isothiazolin-3-one biocidal active compound; and
ii) at least one guanidine adjuvant of formula (I) or a salt thereof,
(CH₃)₂N—(C═NHR)—N(CH₃)₂ (I)
wherein R is H, C₁-C₃₀-alkyl, C₁-C₃₀-alkenyl, C₁-C₃₀-alkynyl, C₇-C₃₀-alkylaryl, C₆-C₁₂-aryl, or —COR′, wherein R′ is C₁-C₃₀-alkyl or

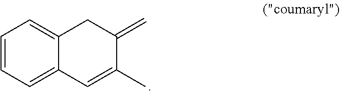

2. The biocidal composition according to claim 1, wherein the at least one 4-isothiazolin-3-one biocidal active compound is selected from the group consisting of 1,2-benzisothiazolin-3-one (BIT), N-(n-butyl)-1,2-benzisothiazolin-3-one (BBIT), 5-chloro-2-methyl-2H-isothiazolin-3-one (CMIT), 2-methyl-2H-isothiazolin-3-one (MIT), 2-methyl-4,5-trimethylene-4-isothiazolin-3-one (MTI), 2-octyl-3 (2H)-isothiazolone (OIT), dichloro-n-octyl-2H-isothiazolin-3-one (DCOIT), N-methyl-1,2-benzisothiazolin-3-one (nMBIT) and 2,2-dithiobis(N-methylbenzamide) (DTMB).

3. The biocidal composition according to claim 1, wherein the at least one 4-isothiazolin-3-one biocidal active compound is 1,2-benzisothiazolin-3-one (BIT), or N-(n-butyl)-1,2-benzisothiazolin-3-one (BBIT), or a mixture thereof.

4. The biocidal composition according to claim 1, wherein the weight ratio of the guanidine adjuvant to the 4-isothiazolin-3-one biocidal active compound is from about 200:1 to 1:1.

5. The biocidal composition according to claim 3, wherein the weight ratio of the guanidine adjuvant to 1,2-benzisothiazolin-3-one (BIT) is from about 200:1 to 1:1.

6. The biocidal composition according to claim 3, wherein the weight ratio of the guanidine adjuvant to N-(n-butyl)-1,2-benzisothiazolin-3-one (BBIT) is from about 200:1 to 1:1.

7. The biocidal composition according claim 1, wherein the guanidine adjuvant is selected from the group consisting of 1,1,3,3-tetramethylguanidine (TMG) and 2-tert-butyl-1,1,3,3-tetramethylguanidine, or a salt thereof.

8. The biocidal composition according to claim 7, wherein the guanidine adjuvant is 1,1,3,3-tetramethylguanidine (TMG), or a salt thereof.

9. A biocidal product comprising a biocidal composition according to claim 1.

10. The biocidal product according to claim 9, wherein the at least one 4-isothiazolin-3-one biocidal active compound is present in an amount of from about 1 to 500 ppm.

11. The biocidal product according claim 9, wherein the at least one 4-isothiazolin-3-one biocidal active compound is 1,2-benzisothiazolin-3-one (BIT) or N-(n-butyl)-1,2-benzisothiazolin-3-one (BBIT) or a mixture thereof, wherein 1,2-benzisothiazolin-3-one (BIT) is present in an amount of from about 1 to 100 ppm and/or N-(n-butyl)-1,2-benzisothiazolin-3-one (BBIT) is present in an amount of from about 1 to 130 ppm.

12. The biocidal product according to claim 11, wherein 1,2-benzisothiazolin-3-one (BIT) is present in an amount of from about 1 to 90 ppm, and/or wherein N-(n-butyl)-1,2-benzisothiazolin-3-one (BBIT) is present in an amount of from about 10 to 130 ppm.

13. The biocidal product according to claim 9, wherein the guanidine adjuvant is present in an amount of from about 500 to 1000 ppm.

14. The biocidal product according to claim 9, wherein the 4-isothiazolin-3-one biocidal active compound is 1,2-benzisothiazolin-3-one (BIT), which is present in the biocidal product in an amount of from about 10 to 90 ppm; and the guanidine adjuvant is 1,1,3,3-tetramethylguanidine, which is present in the biocidal product in an amount of from about 500 to 990 ppm.

15. The biocidal product according to claim 9, wherein the 4-isothiazolin-3-one biocidal active compound is a mixture of 1,2-benzisothiazolin-3-one (BIT) and N-(n-butyl)-1,2-benzisothiazolin-3-one (BBIT), and the guanidine adjuvant is 1,1,3,3-tetramethyl guanidine, wherein in the biocidal product 1,2-benzisothiazolin-3-one (BIT) is present in an amount of from about 10 to 90 ppm, N-(n-butyl)-1,2-benzisothiazolin-3-one (BBIT) is present in an amount of from about 5 to 140 ppm and 1,1,3,3-tetramethylguanidine is present in an amount of from about 200 to 970 ppm.

16. The biocidal product according to claim 9, wherein the biocidal product is selected from the group consisting of a paint, a coating, a sealant, a plaster, a starch solution, an aqueous mineral slurry, a dispersion, a caulk, a slurry of colored pigments, a slurry of inorganic fillers and colored pigments, a construction chemical product, a glue or adhesive, a polymer dispersion, an emulsion polymer, a detergent or cleaner, a mineral oil or mineral oil product, a cooling lubricant, an auxiliary for leather and/or textile and/or photochemical industry, a pre-product or intermediate of the chemical industry, a wax, a clay emulsion, an ink and a disinfectant.

17. The biocidal product according to claim 16, wherein the biocidal product is selected from the group consisting of a paint, a coating, an emulsion polymer and an aqueous mineral slurry.

18. A method for protecting a locus subject or susceptible to infestation with and/or destruction or deterioration by microorganisms, by incorporating into or onto the locus in an amount which is effective to adversely affect the growth and/or survival of said microorganisms the biocidal composition according to claim 1.

19. Use of at least one guanidine adjuvant for enhancing the biocidal activity of at least one 4-isothiazolin-3-one biocidal active compound in a biocidal composition according to claim 1, wherein guanidine adjuvant is guanidine derivative of formula (I), or a salt thereof,
(CH₃)₂N—(C═NHR)—N(CH₃)₂ (I)
wherein R is H, C₁-C₃₀-alkyl, C₁-C₃₀-alkenyl, C₁-C₃₀-alkynyl, C₇-C₃₀-alkylaryl, C₆-C₁₂-aryl, or —COR′, wherein R′ is C₁-C₃₀-alkyl or [chemical structure]
